(19) United States
(12) Patent Application Publication
(10) Pub. No.: US 2023/0168499 A1
(43) Pub. Date: Jun. 1, 2023

(54) DISPLAY DEVICE HAVING A STABILIZATION AND ADJUSTMENT MECHANISM FOR ANTI-REFLECTION SLATS

(71) Applicant: Continental Automotive Technologies GmbH, Hannover (DE)

(72) Inventors: Felicitas Wille, Frankfurt am Main (DE); Klaus Seifert, Frankfurt am Main (DE)

(73) Assignee: Continental Automotive Technologies GmbH, Hannover (DE)

(21) Appl. No.: 17/921,801

(22) PCT Filed: Apr. 21, 2021
(86) PCT No.: PCT/DE2021/200050

§ 371 Date: Oct. 27, 2022

(30) Foreign Application Priority Data
Apr. 29, 2020 (DE) 10 2020 205 443.6
Apr. 29, 2020 (DE) 10 2020 205 445.2

(51) Int. Cl. G02B 27/01

(52) U.S. Cl. CPC G02B 27/0101; G02B 2027/0118; G02B 2207/123

(57) ABSTRACT

A device for generating a virtual image comprising a display element for generating an image, an optical waveguide for expanding an exit pupil, and an antiglare element, which is arranged after the optical waveguide in a beam path and is configured as a shutter comprising slats, wherein the slats are arranged variably in their setting angle during operation is disclosed.

### CROSS REFERENCE TO RELATED APPLICATIONS

This U.S. patent application claims the benefit of PCT patent application No. PCT/DE2021/200050, filed Apr. 21, 2021, which claims the benefit of German patent application No. 10 2020 205 443.6, filed Apr. 29, 2020, and German patent application No. 10 2020 205 445.2, filed Apr. 29, 2020, all of which are hereby incorporated by reference.

### TECHNICAL FIELD

The present disclosure relates to a stabilization and adjustment mechanism for antireflection slats of a display apparatus having a picture generating unit with a display element for displaying an image and an optics unit for projecting the image onto a projection surface.

### BACKGROUND

Such display apparatuses may, for example, be used for a head-up display for a transport. A head-up display, also referred to as a HUD, is intended to mean a display system in which the viewer can maintain their viewing direction since the contents to be represented are superposed into their visual field. While such systems were originally used primarily in the aerospace sector due to their complexity and costs, they are now also being used in large-scale production in the automotive sector.

Head-up displays generally consist of an image generator, an optics unit, and a mirror unit. The image generator produces the image. The optics unit directs the image onto the mirror unit. The image generator is often also referred to as a picture generating unit or PGU. The mirror unit is a partially reflective, light-transmissive pane. The viewer thus sees the contents represented by the image generator as a virtual image and at the same time sees the real world behind the pane. In the automotive sector, the windshield is often used as the mirror unit, and the curved shape of the windshield must be taken into account in the representation. Due to the interaction of the optics unit and the mirror unit, the virtual image is an enlarged representation of the image produced by the image generator.

The viewer can view the virtual image only from the position of the so-called eyebox. A region whose height and width correspond to a theoretical viewing window is referred to as an eyebox. As long as one of the viewer's eyes is within the eyebox, all elements of the virtual image are visible to that eye. If, on the other hand, the eye is outside the eyebox, the virtual image is only partially or not at all visible to the viewer. The larger the eyebox is, the less restricted the viewer is in choosing their seating position.

The size of the eyebox of conventional head-up displays is limited by the size of the optics unit. One approach for enlarging the eyebox is to couple the light coming from the picture generating unit into an optical waveguide. The light that is coupled into the optical waveguide undergoes total internal reflection at the interfaces of the latter and is thus guided within the optical waveguide. In addition, a portion of the light is coupled out at a multiplicity of positions along the propagation direction. Owing to the optical waveguide, the exit pupil is in this way expanded. The effective exit pupil is composed here of images of the aperture of the image generation system.

Against this background, US 2016/0124223 A1 describes a display apparatus for virtual images. The display apparatus comprises an optical waveguide that causes light that emanates from a picture generating unit and is incident through a first light incidence surface to repeatedly undergo total internal reflection in order to travel in a first direction away from the first light incidence surface. The optical waveguide also has the effect that a portion of the light guided in the optical waveguide emerges outward through regions of a first light exit surface, which extends in the first direction. The display apparatus further comprises a first diffraction grating on the light-incidence side, which diffracts incident light so as to make the diffracted light enter the optical waveguide, and a first light-emergence diffraction grating, which diffracts light that is incident from the optical waveguide. US 2012/0224062 A1 also relates to a display apparatus for virtual images with an optical waveguide.

In the currently known design of such a device, in which the optical waveguide consists of glass plates within which diffraction gratings or holograms are arranged, a problem arises if light is incident from the outside. By reflections of the externally incident light, stray light may enter the users eye. The contrast of the virtual image perceived by the user is furthermore reduced.

In conventional devices, reflective components are therefore wherever possible tilted and combined with glare traps, so that reflections do not reach the region in which the drivers eye is expected to be. Alternatively, antireflection coatings are employed and structural roughnesses are used in order to reduce the reflection intensity.

The tilting of components significantly takes up installation space, which is limited in automobiles. Furthermore the performance of the components is generally reduced by tilted installation. Layers and structures lessen the achievable intensity, but the reflections generally remain clearly visible and significantly reduce the contrast.

DE 10 2018 213 061 A1 discloses a device for generating a virtual image, having a display element for generating an image, an optical waveguide for expanding an exit pupil and an antiglare element, which is arranged after the optical waveguide in the beam path and is configured as a shutter comprising slats. JP 2017-165 163 A discloses a head-up display in which slats that are fixed during operation are likewise used.

It is an object of the present disclosure to provide an improved device for generating a virtual image, with which the influence of stray light is reduced.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A device according to the disclosure for generating a virtual image comprises a display element for generating an image, an optical waveguide for expanding an exit pupil, and an antiglare element, which is arranged after the optical waveguide in the beam path and is configured as a shutter comprising slats, the slats being arranged variably in their setting angle during operation. The antiglare element may be adapted to an emission angle that varies during operation. Such a change occurs, for example, when an adaptation to the driver's height and therefore a change in the position of the eyebox takes place. Without the variability according to the disclosure of the setting angle of the slats during operation, this would require the provision of a larger angle range through which light may pass through the slats, which increases the occurrence of irritation by stray light.

A device according to the disclosure comprises stabilization threads which are in contact with the slats. This configuration prevents or reduces shape changes of the slats, and therefore deviations from the setting angle currently adjusted. For a setting angle which is variable according to the disclosure during operation of the device, stabilization that may be combined with a variable setting angle is desirable. Stabilization threads are particularly suitable for this. Further advantages of stabilization threads are that they are particularly thin and therefore scarcely reduce or influence the image quality, even if they extend through the beam path.

In one embodiment, the slats comprise openings through which the stabilization threads extend. The slats and stabilization threads are independent of one another in a direction in which no stabilization is required. The shape of the openings may be configured accordingly. Different thermal expansion coefficients in the event of different material properties of slats and stabilization threads therefore have no effect.

In one embodiment, the slats and stabilization threads are connected to one another by glue points. The connection may be carried out at openings of the slats or at the edge border of the slats, or at another suitable location. The connection that is provided increases the stability when using materials having approximately the same thermal expansion. Furthermore, in this case adjustment of the angle setting may be carried out by the stabilization threads.

In one embodiment, the stabilization threads are coated with an adhesive material. It is therefore not necessary to apply individual glue points. Connection is carried out after slats and stabilization threads have been positioned relative to one another by bringing them in contact. Optionally, the adhesive material is converted into a particularly active state when bringing them in contact, in order to achieve the contacting rapidly and/or particularly stably. This may for example be carried out by heating, by UV irradiation or by another treatment which is suitable for the materials used.

In one embodiment, the stabilization threads are arranged in a frame not parallel to the longitudinal direction of the slats. The frame is in this case used for stable arrangement of the stabilization threads. In directions which are at an angle to the longitudinal direction of the slats, there is a particular need for stabilization since the slats are inherently least stable in these directions. The proposed solution prevents, inter alia, so-called fluttering of the slats. If the stabilization threads are aligned at an angle of 90° with respect to the longitudinal direction of the slats, this is particularly suitable for varying their setting angle by the stabilization threads. A deviation from 90° may increase the stability, depending on the particular circumstances. A suitable angle may be selected according to requirements.

In one embodiment, at least some of the stabilization threads are interwoven with one another. Transverse stabilization of the stabilization threads with respect to one another may therefore be achieved with a small number of stabilization threads that are directly in contact with one another. In the simplest case, only stabilization threads arranged directly next to one another are in direct contact with one another.

According to a further aspect of the disclosure, the slats are arranged on a spring element at their end regions located in the longitudinal direction. This arrangement may be configured either as a firm connection or by bearing of the end regions on the spring element. The setting angle is therefore determined by the inclination of the region of the spring element on which the slat is arranged. By compressing or expanding the spring element, the setting angle of the slats may be varied in a defined way, and is therefore adjustable without great outlay. Stabilization by stabilization threads is also advantageous in this case, although the desired effect of adjusting the setting angle may also be achieved without stabilization threads.

In one embodiment, a broad spring is provided as the spring element and the end regions respectively of two slats at the same fastening location of the broad spring are respectively arranged opposite one another in the direction of their width. This allows two times the number of slats per spring turn. It may be used to increase the number of slats or to reduce the number of spring turns required, or in a suitable combination thereof.

In one embodiment, the end regions respectively of two slats at the same fastening location of the spring element are respectively arranged opposite one another, and at least one of the respective end regions is arranged by a spacer. This allows two times the number of slats per spring turn, without a broad spring being required therefor.

Further features of the present disclosure will become apparent from the following description and the appended claims in conjunction with the figures. It should be understood that the detailed description and specific examples, while indicating the preferred embodiment of the disclosure, are intended for purposes of illustration only and are not intended to limit the scope of the disclosure.

### BRIEF DESCRIPTION OF THE DRAWINGS

FIG. 1 schematically shows a head-up display according to the prior art for a motor vehicle;

FIG. 2 shows an optical waveguide with two-dimensional enlargement;

FIG. 3 schematically shows a head-up display with an optical waveguide;

FIG. 4 schematically shows a head-up display with an optical waveguide in a motor vehicle;

FIG. 5 schematically shows a head-up display with an optical waveguide and antireflection as an antiglare element;

FIG. 6 shows an alternative optical waveguide with two-dimensional enlargement;

FIG. 7 schematically shows a device according to the disclosure for generating a virtual image;

FIG. 8 shows a shutter and a detail enlargement thereof;

FIG. 9 shows an alternative embodiment with stabilization threads;

FIG. 10 shows an alternative embodiment with stabilization threads;

FIG. 11 shows an alternative embodiment with stabilization threads;

FIG. 12 shows an alternative embodiment with stabilization threads;

FIG. 13 shows a further alternative embodiment with stabilization threads;

FIG. 14 shows a further alternative embodiment with stabilization threads;

FIG. 15 shows a further alternative embodiment with stabilization threads;

FIG. 16 shows an alternative embodiment;

FIG. 17 shows the arrangement of slats in a frame;

FIG. 18 shows an alternative embodiment; and

FIG. 19 shows an alternative embodiment.

### DETAILED DESCRIPTION

For a better understanding of the principles of the present disclosure, embodiments of the disclosure will be explained in more detail below with reference to the figures. The same references are used in the figures for identical or functionally identical elements and are not necessarily described again for each figure. It is to be understood that the disclosure is not restricted to the embodiments represented, and that the features described may also be combined or modified without departing from the scope of protection of the disclosure, as defined in the appended claims.

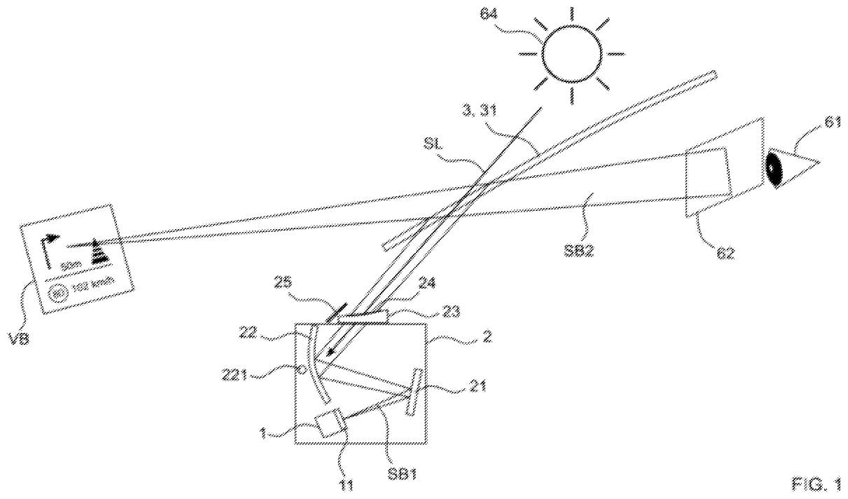

First, the basic concept of a head-up display with an optical waveguide will be explained with reference to FIGS. 1 to 4.

FIG. 1 shows a schematic diagram of a head-up display according to the prior art for a motor vehicle. The head-up display comprises an image generator 1, an optics unit 2, and a mirror unit 3. A beam of rays SB1 emanates from a display element 11 and is reflected by a folding mirror 21 onto a curved mirror 22, which reflects it in the direction of the mirror unit 3. The mirror unit 3 is represented here as a windshield 31 of a motor vehicle. From there, the beam of rays SB2 travels in the direction of an eye 61 of a viewer.

The viewer sees a virtual image VB that is located outside the motor vehicle, above the engine hood or even in front of the motor vehicle. Due to the interaction of the optics unit 2 and the mirror unit 3, the virtual image VB is an enlarged representation of the image displayed by the display element 11. A speed limit, the current vehicle speed, and navigation instructions are symbolically represented here. As long as the eye 61 is within the eyebox 62 indicated by a rectangle, all elements of the virtual image are visible to the eye 61. If the eye 61 is outside the eyebox 62, the virtual image VB is only partially or not at all visible to the viewer. The larger the eyebox 62 is, the less restricted the viewer is when choosing their seating position.

The curvature of the curved mirror 22 serves to condition the beam path and thus to ensure a larger image and a larger eyebox 62. In addition, the curvature compensates for a curvature of the windshield 31, with the result that the virtual image VB corresponds to an enlarged reproduction of the image represented by the display element 11. The curved mirror 22 is rotatably mounted by a bearing 221. The rotation of the curved mirror 22 that this allows makes it possible to displace the eyebox 62 and thus to adapt the position of the eyebox 62 to the position of the eye 61. The folding mirror 21 serves to ensure that the path traveled by the beam of rays SB1 between the display element 11 and the curved mirror 22 is long but, at the same time, that the optics unit 2 is nevertheless compact. The optics unit 2 is delimited from the environment by a transparent cover 23. The optical elements of the optics unit 2 are thus protected, for example, against dust located in the interior of the vehicle. An optical film 24 or a coating that is intended to prevent incident sunlight SL from reaching the display element 11 via the mirrors 21, 22 is furthermore situated on the cover 23. Said display element 11 could otherwise be temporarily or permanently damaged by the resulting development of heat. In order to prevent this, an infrared component of the sunlight SL is for example filtered out by means of the optical film 24. Antiglare protection 25 serves to shade light incident from the front, so that it is not reflected by the cover 23 in the direction of the windshield 31, which could cause the viewer to be dazzled. In addition to sunlight SL, the light from another stray light source 64 may also reach the display element 11.

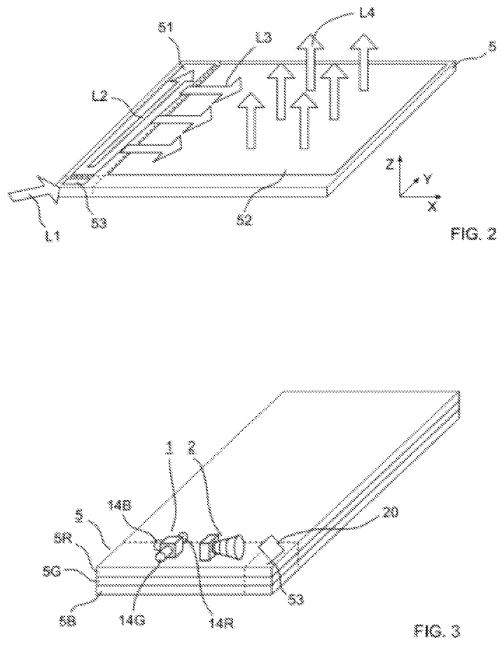

FIG. 2 shows a schematic spatial representation of an optical waveguide 5 with two-dimensional enlargement. The lower left region shows an input coupling hologram 53, by means of which light L1 coming from a picture generating unit (not represented) is coupled into the optical waveguide 5. It propagates therein to the top right in the drawing, according to the arrow L2. In this region of the optical waveguide 5, there is a folding hologram 51 that acts similarly to many partially transmissive mirrors arranged one behind the other and produces a light beam that is broadened in the Y-direction and propagates in the X-direction. This is indicated by three arrows L3. In the part of the optical waveguide 5 that extends to the right in the figure, there is an output coupling hologram 52 that likewise acts similarly to many partially transmissive mirrors arranged one behind the other and couples out light, indicated by arrows L4, upward in the Z-direction out of the optical waveguide 5. In this case, broadening takes place in the X-direction, so that the original incident light beam L1 leaves the optical waveguide 5 as a light beam L4 that is enlarged in two dimensions.

FIG. 6 shows a schematic representation of an optical waveguide with two-dimensional enlargement, which is an alternative to FIG. 2. Here, the output coupling hologram 52 is configured in such a way that it couples light out not perpendicularly to the surface of the optical waveguide 5 but at an angle with respect to the Z-direction, as illustrated by the arrows L4. In this way, the optical waveguide 5 may be arranged according to the available installation space, without having to allow for perpendicular emergence of the light beam enlarged in two dimensions.

FIG. 3 shows a spatial representation of a head-up display with three optical waveguides 5R, 5G, 5B, which are arranged one above the other and each stand for an elementary color red, green, and blue. Together they form the optical waveguide 5. The holograms 51, 52, 53 present in the optical waveguide 5 are wavelength-dependent, so that one optical waveguide 5R, 5G, 5B is respectively used for one of the elementary colors. An image generator 1 and an optics unit 2 are represented above the optical waveguide 5. The optics unit 2 comprises a mirror 20, wherein the light produced by the image generator 1 and shaped by the optics unit 2 is deflected in the direction of the respective input coupling hologram 53. The image generator 1 comprises three light sources 14R, 14G, 14B for the three elementary colors. It can be seen that the entire unit shown has a small overall height compared to its light-emitting surface.

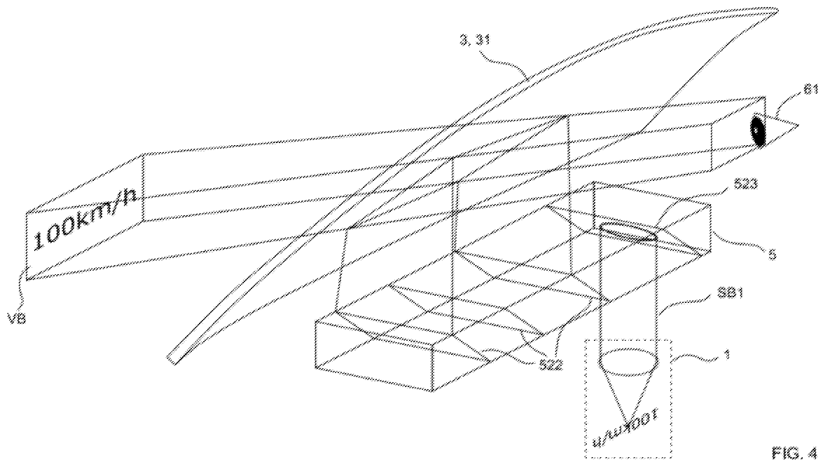

FIG. 4 shows a head-up display in a motor vehicle similarly to in FIG. 1, but here in a spatial representation and with an optical waveguide 5. It shows the schematically indicated image generator 1, which produces a parallel beam of rays SB1 that is coupled into the optical waveguide 5 by the mirror plane 523. The optics unit is not represented for the sake of simplicity. A plurality of mirror planes 522 each reflect a portion of the light incident on them in the direction of the windshield 31, the mirror unit 3. The light is reflected thereby in the direction of the eye 61. The viewer sees a virtual image VB above the engine hood or at an even farther distance in front of the motor vehicle.

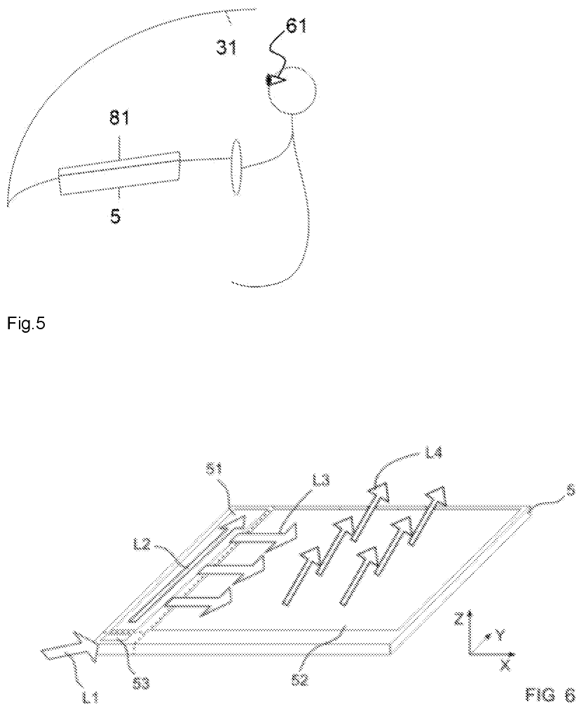

FIG. 5 schematically shows a head-up display with an optical waveguide 5 and antireflection as an antiglare element 81, a windshield 31 and a viewer with an eye 61. The optical waveguide 5 is in this case arranged directly on the antiglare element 81.

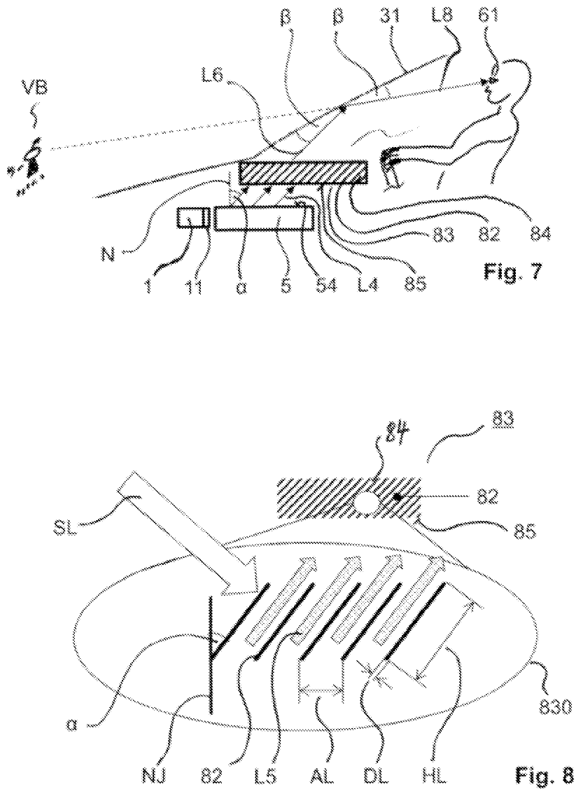

FIG. 7 shows a device according to the disclosure, in which an optical waveguide 5 is used in a manner corresponding to FIG. 6. It shows the image generator 1 with a display element 11 and the optical waveguide 5, from which light L4 emerges at an angle α with respect to the normal N to the light exit surface 54 of the optical waveguide 5, the angle α being greater than 0°. The emerging light L4 impinges on the light entry surface 85 of the shutter 83, the slats 82 of which are arranged parallel to the emerging light L4, so that it may pass unimpeded through the intermediate spaces 84 between the slats 82. The light L6 emerging from the shutter 83 impinges on the windshield 31 at an angle β and is reflected thereby, and enters the eye 61 of a vehicle occupant, here the driver, as light L8. The latter therefore sees a virtual image VB. In this exemplary embodiment, the shutter 83 forms the cover of the optics unit, and a separate cover element is not provided. The shutter 83 may therefore even come in direct contact with objects or persons located in the interior of the vehicle. Damage to the shutter 83 is therefore not precluded. The shutter 83 is therefore arranged releasably so that, if need be, it is removed without great effort and replaceable with a new or repaired shutter 83.

FIG. 8 shows the shutter 83 and a detail enlargement 830. It shows the slats 82, which let through light L5 that emanates from the optical waveguide 5 and travels substantially parallel to the slats 82. Stray light SL that does not travel parallel to the slats 82 is blocked by the slats 82. The slats 82 have a spacing AL from one another and are inclined by an angle α with respect to the normal NJ to the light entry surface 85 of the shutter 83. The slats have a height HL and a thickness DL, the height HL being a multiple of the thickness DL. The angle α corresponds to that of the light emergence from the optical waveguide 5 when the light exit surface 54 of the latter and the light entry surface 85 of the shutter 83 are arranged parallel to one another. In the case of a non-parallel arrangement, these angles are to be converted accordingly. The angle α depends, inter alia, on the position of the driver and their angle of view. For different types of vehicle or different inclinations of the windshield 31, inter alia the spacing AL needs to be adapted. The slats 82 are for example configured to be nonreflective, that is to say substantially black and opaque. If the slats are arranged so as to be tiltable, that is to say the angle α is variably adjustable during operation, they may be adjusted to different positions of the eyebox, or to different positions of the eye 61 inside the eyebox. This assumes that the light emanating from the optical waveguide 5 covers a certain angle range so that, for each angle α set, light rays that are aligned parallel to the slats arrive on the latter and therefore pass through them.

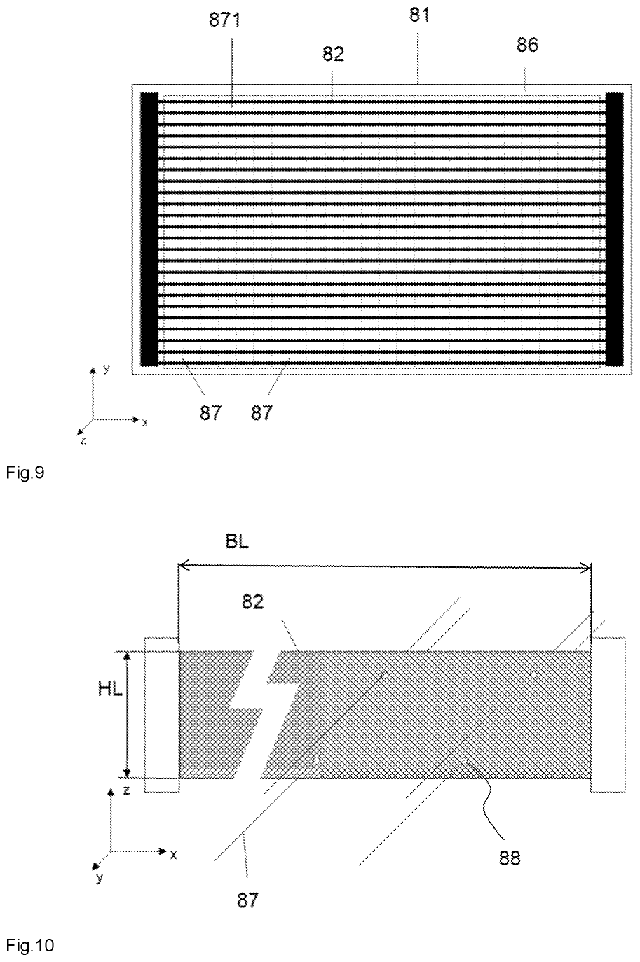

FIG. 9 shows an alternative embodiment with stabilization threads 87. The slats 82 are fixed in position by a plurality of stabilization threads 87 over their length, the extent in the x-direction. Oscillation/vibration of the slats 82 is thus prevented. The slats 82 are fixed in both the x- and z-direction. If the spacing of the stabilization threads 87 with respect to one another is selected to be sufficiently small, the possibility of displacing the slats 82 in the y-direction is also minimized. The stabilization threads 87 may, in one alternative embodiment, be fastened on a frame 86 of the antireflection unit, the antiglare element 81. The diameter of the stabilization threads 87 is selected to be as small as possible in the μm range, so that the stabilization threads 87 interfere with the beam path little or almost not at all, and are therefore not visible in the virtual image VB. Relatively large-area gaps 871 remain, through which light emanating from the optical waveguide 5 may pass unimpeded.

FIG. 10 shows a further alternative embodiment with stabilization threads 87, in which the position of the stabilization threads 87 in relation to the slat height HL varies over the width BL of the slat 82. The stabilization threads 87 may therefore be arranged in one, two or more planes. Openings 88, which are represented here as round holes, through which the stabilization threads 87 extend are furthermore shown. The stabilization threads 87 bear at least pointwise on the edge of the holes, and are therefore in contact with the openings 88.

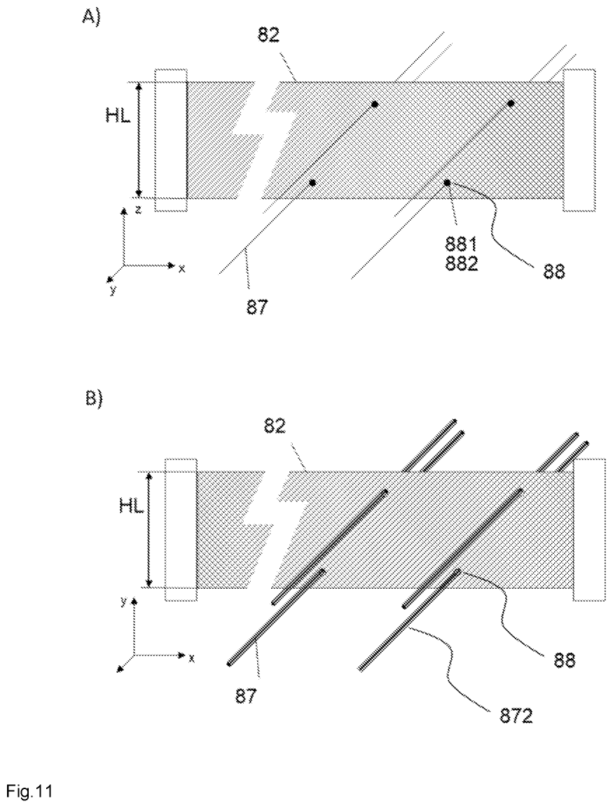

FIG. 11 shows an alternative embodiment with stabilization threads 87, together with fixing and adjustment. If the stabilization threads 87 are also meant to be used for fixing and adjustment, the position of the slats 82 is also fixed in the y-direction. Additionally, in this case noise due to movement of the slats 82 is minimized. In one alternative embodiment, the stabilization threads 87 are fastened on the slats 82 with an adhesive material at glue points 882. In this case, the fixing points 881 are configured in such a way that they are not visible in the virtual image, for example by a minimal amount of glue at the glue points 882. In this regard, see the upper part A of the figure. In a further alternative embodiment, the stabilization threads 87 are provided with an adhesive material 872. The visibility of the fixing points 881 in the virtual image is thus minimized. In this regard, see the lower part B of the figure. The fixing points 881 are located in the region of the gaps 871.

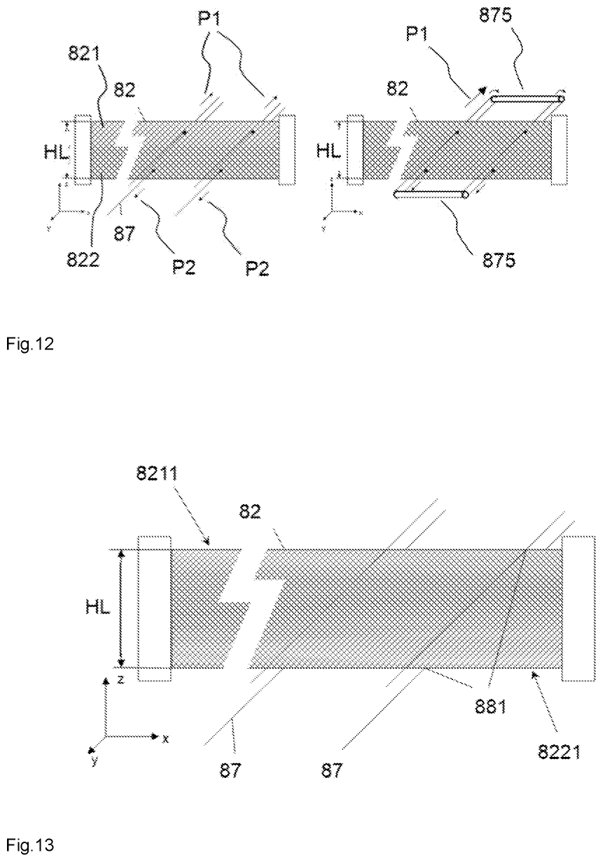

FIG. 12 shows an alternative embodiment with stabilization threads 87. Here, the stabilization threads are used in combination with adhesive material 872 for adjusting the setting angle γ of the slats 82. In this case, the upper side 821 of the slats 82 is displaced in the negative y-direction (arrows P1) and the lower side 822 of the slats 82 is displaced in the positive y-direction (arrows P2). The adjustment of the threads in the upper and lower part of the slats 82 may take place separately, see the left of the figure, or together, see the right of the figure. Return rollers 875, by means of which the coordinated movement of the stabilization threads 87 and therefore the variation of the setting angle γ are achieved, are schematically indicated on the right in the figure.

FIG. 13 shows a further alternative embodiment with stabilization threads 87. Here, the stabilization threads 87 are fastened with adhesive material 872 (not represented here) or with an adhesive coating 873 on the lower edge 8221 and the upper edge 8211 of the slats 82 at fixing points 881, without holes or other openings 88 for passage being needed in the slats 82.

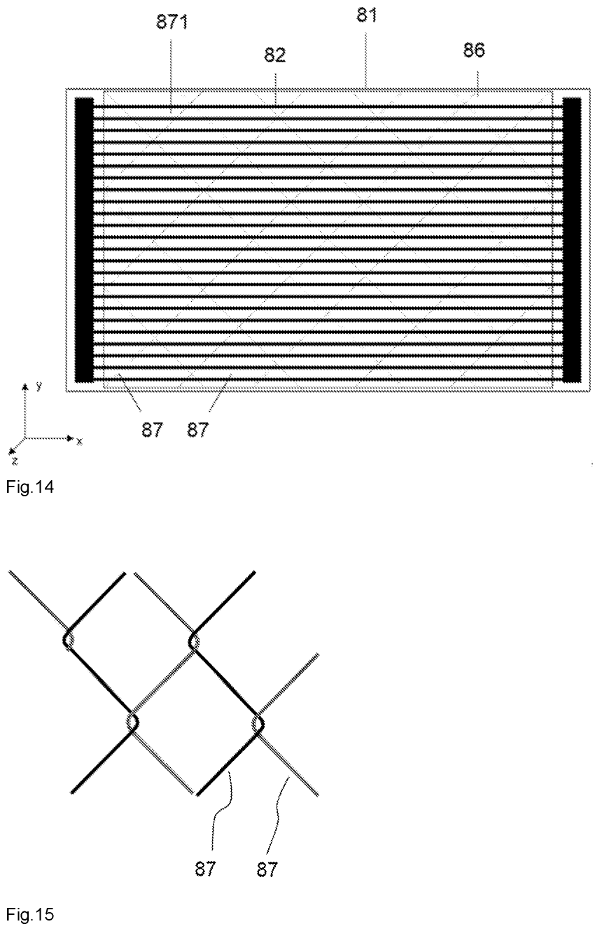

FIG. 14 shows a further alternative embodiment with stabilization threads 87. Here, the stabilization threads 87 extend diagonally with respect to the slats 82 and therefore themselves form a grid. In this alternative embodiment as well, it is possible to arrange the stabilization threads in one, two or more planes. The gaps 871 have an irregular instead of rectangular shape here. It may be seen that the stabilization threads 87 are arranged in a frame 86. In the embodiment represented, the frame 86 is arranged on the antiglare element 81.

FIG. 15 shows a further alternative embodiment with stabilization threads 87. Here, the stabilization threads 87 are interwoven with one another. The figure shows an exemplary variant of the interweaving of the stabilization threads 87. In this case, an arbitrary stabilization thread 87 is interwoven with its two neighboring stabilization threads 87.

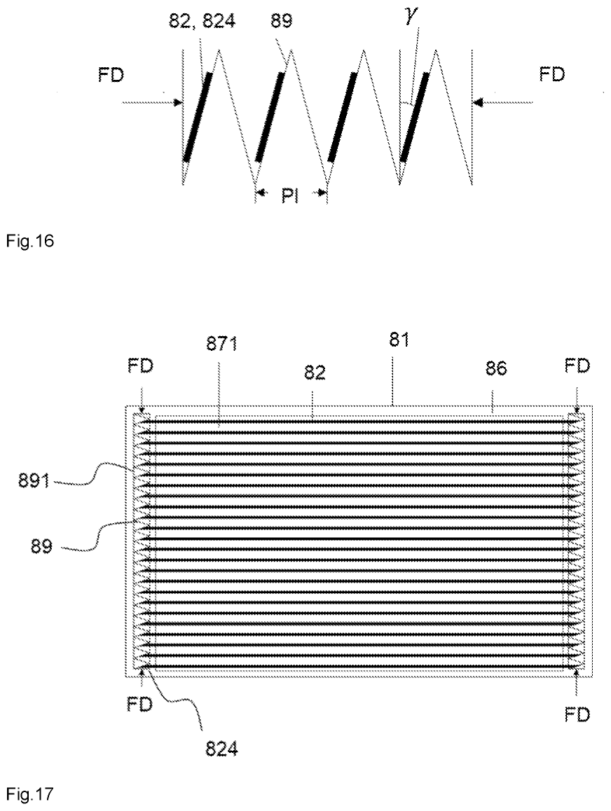

FIG. 16 shows an alternative embodiment with slats 82 arranged on a spring as a spring element 89. End regions 824 of the slats 82 are fixed on spring elements 89—predominantly compression springs—that have a particular inclination angle. This inclination angle may—if necessary—be varied by changing the diameter of the spring element 89 over the length. In the coil spring schematically represented here, the spacing PI (pitch) between two turns of the spring element 89 is constant. In the case of contraction of the compression springs by a pressure force FD (elongation in the case of extension springs), the inclination angle is varied equally over the entire length of the spring element 89 for all slats 82, and therefore so is their setting angle γ. The functional principle of the invention is shown here.

FIG. 17 shows the arrangement of slats 82 in a frame 86. The spring elements 89 are guided through a housing 891 in order to define their position over the entire length. In the design of the slats 82, it is taken into account that the slat spacing varies with the setting angle γ. Very precise adjustment of the angle is ensured (intended/actual deviation of the angle as minimal as possible) since springs may be manufactured precisely even in mass production. Very uniform adjustment of the setting angle γ for all slats 82 is highly advantageous particularly when being used for head-up displays (spring characteristic: equal angle in all turns).

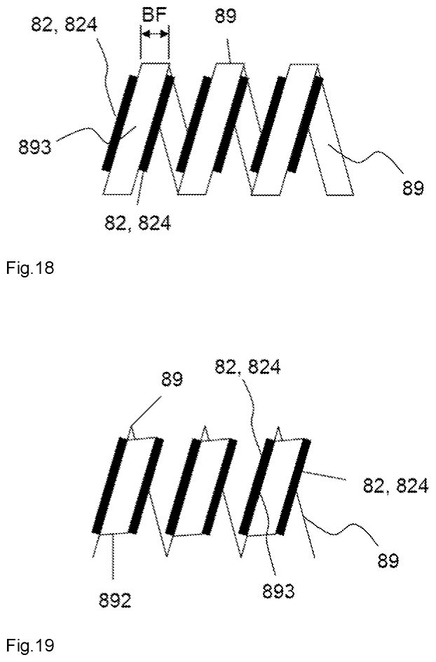

FIG. 18 shows an alternative embodiment with an increased number of slats 82 per spring turn. The slat spacing is halved by placing slats 82 at a fastening location 893 on the upper and lower side of the spring turns. Here, a broad spring with a spring width BF is provided as the spring element 89.

FIG. 19 shows an alternative embodiment with spacers 892. In the exemplary embodiment represented here, a spacer 892 is provided, which is fastened on a fastening location 893 and on which the end region 824 of a slat 82 bears, while another slat 82 is fastened with its end region 824 directly on the fastening location 893. The use of spacers 892 allows the use of a less broad spring 89. Depending on the spring configuration, different adaptations are therefore provided.

In other words, the disclosure relates to the following: Antireflection is carried out in head-up displays by a so-called glare trap as an antiglare element 81 with a curved film. This design has a minimum installation depth corresponding to the film curvature as a consequence. Antireflection of head-up displays which use the windshield 31 as a mirror element, or projection surface, is carried out by slats 82 or a grid structure as a terminating module, see for example FIG. 5. Particularly for head-up displays with optical waveguides 5 in flat fitting, an antireflection solution is needed since flat glass components directly under the windshield 31 are particularly susceptible to perturbing reflections. This solution is preferably angle-adjustable in order to reduce shading in the eyebox 62. Slats 82 secured in a frame 86 are for example provided for the antireflection.

According to the disclosure, different setting angles γ of the slats 82 are made possible for different eyebox positions. This helps to avoid undesired shading. The disclosure proposes a secured solution for allowing the angle adjustment of the slats 82.

In head-up displays with optical waveguides 5 in flat fitting, an important module is fitted directly behind the windshield 31, so that high thermal stresses may occur, for example due to sunlight.

According to the disclosure, possible vibration of the slats 82 is reduced. Vibration may lead to distortion/curvature of the slats 82. This would lead to shading in the virtual image VB of the head-up display.

According to the disclosure, automobile-compatible angle adjustment, which is distinguished by thermal stability and longterm stability, is proposed for slats 82. Slats 82 without stabilization according to the disclosure are prone to oscillations (distortion/curvature) in the vehicle during driving. Advantages of the solutions according to the disclosure are, inter alia: thermal strength since stabilization threads 87 with a stable, temperature-independent behavior are used, or metal springs with a stable temperature-independent behavior as spring elements 89. Longterm stability: no relevant material aging takes place in stabilization threads 87, or in metal springs as a spring element 89. Uniform angle adjustment of all slats 82 in the component after setting up has been carried out. Only a single element is needed for the angle adjustment—each slat 82 does not need to be adjusted or controlled individually.

The solution according to the disclosure may also be employed in conventional head-up displays (for example based on mirrors). Here, the antiglare element 81 is preferably used as a terminating module. The solution according to the disclosure may also be used as adjustable antireflection inside modules. The antiglare element 81 is then integrated into the module. The solution according to the disclosure may also be used as privacy protection for displays (privacy filter) as an adaptive solution. The solution according to the disclosure may also be used as privacy protection for windows/domelight windows (smartwindows) for brightness adjustment. The solution according to the disclosure is also usable for military applications (reflection avoidance for telescopic sights) or for reflection avoidance for cameras and surveillance cameras.

1. A device for generating a virtual image, comprising:
a display element for generating an image;
an optical waveguide for expanding an exit pupil; and
an antiglare element, which is arranged after the optical waveguide in a beam path and is configured as a shutter comprising slats, wherein the slats are arranged variably in their setting angle during operation.

2. The device as claimed in claim 1, comprising stabilization threads, which are in contact with the slats.

3. The device as claimed in claim 2, wherein the slats comprise openings through which the stabilization threads extend.

4. The device as claimed in claim 2, wherein slats and stabilization threads are connected to one another by glue points.

5. The device as claimed in claim 2, wherein the stabilization threads are coated with an adhesive material.

6. The device as claimed in claim 2, wherein the stabilization threads are arranged in a frame not parallel to a longitudinal direction of the slats.

7. The device as claimed in claim 2, wherein at least some of the stabilization threads are interwoven with one another.

8. The device as claimed in claim 1, wherein the slats are arranged on a spring element at end regions located in a longitudinal direction.

9. The device as claimed in claim 8, wherein a broad spring is the spring element and the end regions respectively of two slats at a fastening location of the broad spring are respectively arranged opposite one another in the direction of their width.

10. The device as claimed in one of claim 8, wherein the end regions respectively of two slats at the fastening location of the spring element are respectively arranged opposite one another, and at least one of the respective end regions is arranged by a spacer.
